(19) United States
(12) Patent Application Publication
(10) Pub. No.: US 2001/0053669 A1
(43) Pub. Date: Dec. 20, 2001

(54) Communication network system

(75) Inventors: Youiti Kado, Kyoto (JP); Masakatsu Kosuga, Kyoto (JP)

Correspondence Address: Gerald T. Bodner, Esq., HOFFMANN & BARON, LLP, 6900 Jericho Turnpike, Syosset, NY, 11791, US

(73) Assignee: ATR Adaptive Communications Research Laboratories

(21) Appl. No.: 09/883,522

(22) Filed: Jun. 18, 2001

(30) Foreign Application Priority Data
Jun. 20, 2000 (JP) 2000-184312

(51) Int. Cl. H04B 3/36

(52) U.S. Cl. 455/7; 455/11.1; 455/16; 455/18

(57) ABSTRACT

A communication network system includes a mobile node and a plurality of fixed nodes. The mobile node is a node moving along a predetermined route, and the fixed node is a node to be fixed along the predetermined route. A packet signal is sent to a destination node by way of those mobile nodes and fixed nodes. In other words, a packet communication among the fixed nodes is carried out by way of the mobile node.

### BACKGROUND OF THE INVENTION

1. Field of the Invention

The present invention relates to a communication network system. Specifically the present invention relates to a communication network system to carry out a data communication by way of a plurality of wireless communications terminals.

2. Description of the Prior Art

When a communication network is to be constructed not only in premises but also in a larger area such as a residential area, a multiplicity of access points (a communication terminal) need to be provided in predetermined intervals. Furthermore, in order to function as a communication network, a framework to exchange data among each access point is necessary. Here are two conceivable methods to exchange data among the access points; (1) is to use a wireless radio wave, and (2) is to install a cable.

However, the method (1) to use a wireless radio wave needs a radio wave as strong as possible in order to exchange data among the access points, thus resulting in a deteriorated radio wave environment. The method (2) to install a cable not only needs a construction cost but also is difficult in changing a disposition of the access point after the cable installation.

### SUMMARY OF THE INVENTION

Therefore, the primary object of this present invention is to provide a communication network system able to prevent a radio wave environmental deterioration, in addition to be constructed at a low cost.

According to this present invention, in a communication network system to send a data signal by way of a plurality of wireless communication terminals, a plurality of wireless communication terminals includes at least one mobile communication terminal moving on a predetermined route and a plurality of fixed communication terminals fixed along the predetermined route. A data signal is sent by way of the fixed communication terminal and the mobile communication terminal. In other words, a communication between the fixed communication terminals is carried out by way of a mobile communication terminal. Therefore, the communication does not require a strong radio wave, thus making it possible to prevent a radio wave environmental deterioration.

In the presence of a plurality of the mobile communication terminals, each of the fixed communication terminals has time information showing a necessary time to transfer a data signal to other fixed communication terminals by way of each of the mobile communication terminals, and a timetable of each of the mobile communication terminals. The fixed communication terminal specifies the mobile communication terminal to which the data signal is transferred based upon the time information and the timetable.

The mobile communication terminal to be specified is preferably a mobile communication terminal to reach a desired fixed communication terminal in the shortest time. This made it possible to shorten a required time for the communication.

The predetermined route is a circulating route, and when a plurality of mobile communication terminals include a first mobile communication terminal and a second mobile communication terminal each of which circulate in a mutually reverse direction each other, the time information preferably includes first terminal information corresponding to a first mobile communication terminal and second time information corresponding to a second mobile communication terminal.

The predetermined route includes a first route and a second route contacting each other, and in case the specified fixed communication terminal is fixed on a contacting point of the first route and the predetermined route, each of the mobile communication preferably stores first terminal information showing a plurality of fixed communication terminals fixed along its own moving route. In the absence of the desired fixed communication terminal in the first terminal information, the mobile communication terminals transfers the data signal to the specified fixed communication terminal.

Preferably the specified fixed communication terminal has second terminal information to show the fixed communication terminal fixed along each of the first route and said second route.

In one embodiment of this present invention, the mobile communication terminal is provided in a regularly operating bus, and the fixed communication terminal is provided in a stop point of the above regularly operating bus.

According to this invention, in the communication network system to send the data signal by way of a plurality of wireless communication terminals, a plurality of wireless communication terminal includes at least one first communication terminal moving on the predetermined route, and a plurality of second communication terminals existing along the predetermined route. The data signal is sent by way of the first communication terminal and the second communication terminal. Therefore, the communication does not require a strong radio wave, thus making it possible to prevent a radio wave environmental deterioration.

The above described objects and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is an illustrative view showing one example of a communication network of this present invention;

FIG. 2 is a block diagram showing one example of a fixed node, a user node and a mobile node;

FIG. 3 is an illustrative view showing one example of a profile data provided in the user node;

FIG. 4 is an illustrative view showing one example of a connection node information table provided in the user node;

FIG. 5 is an illustrative view showing one example of a packet storage area provided in the user node;

FIG. 6 is an illustrative view showing one example of a profile data provided in the fixed node;

FIG. 7 is an illustrative view showing one example of a service-offering destination table provided in the fixed node;

FIG. 8 is an illustrative view showing another example of a profile data provided in the fixed node;

FIG. 9 is an illustrative view showing another example of a service-offering destination node table provided in the fixed node;

FIG. 10 is an illustrative view showing one example of a packet storage area provided in the fixed node;

FIG. 11 is an illustrative view showing one example of a profile data provided in the mobile node;

FIG. 12 is an illustrative view showing one example of a profile data provided in the mobile node;

FIG. 13 is an illustrative view showing one example of a packet storage area provided in the mobile node;

FIG. 14 is a flow diagram showing a part of operation of the user node;

FIG. 15 is a flow diagram showing another part the of operation of the user node;

FIG. 16 is a flow diagram showing a part of the operation of the user node;

FIG. 17 is a flow diagram showing another part of the operation of the user node;

FIG. 18 is a flow diagram showing still another part of the operation of the user node;

FIG. 19 is a flow diagram showing a part of the operation of the mobile node;

FIG. 20 is a flow diagram showing another part of the operation of the mobile node; and

FIG. 21 is a flow diagram showing still another part of the operation of the mobile node.

### DETAILED DESCRIPTION OF THE PREFERRED EMBODIMENTS

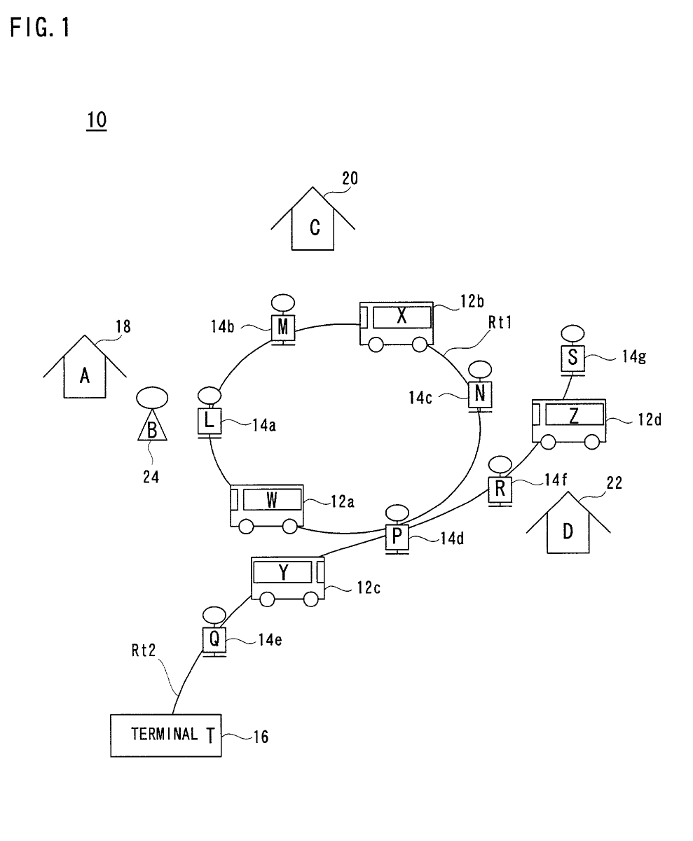

Referring to FIG. 1, a communication network system 10 of this embodiment includes a mobile communication terminal (mobile node) W, X, Y and Z provided in a regularly operating bus 12a, 12b, 12c, and 12d respectively, and a fixed communication terminal (fixed node) L, M, N, 0, P, Q, R, S and T provided in a stop point 14a, 14b, 14c, 14d, 14e, 14f, 14g and a terminal 16 respectively. The stop points 14a, 14b, 14c and 14d form a first route Rt1 in a form of a loop. The stop points 14d, 14e, 14f, 14g and the terminal 16 form a linear second route Rt2. The terminal 16 is connected with another communication network system (not shown).

The regularly operating bus 12a and 12sb travel the first route Rt1 in accordance with a predetermined timetable. The regularly operating bus 12c and 12d travel the second route Rt2 in accordance with a predetermined timetable. The regularly operating bus 12a and 12sb travel the first route Rt1 in a reverse direction each other.

A store 18 provided with a user communication terminal (user node) A exists in vicinity of the stop point 14a, and a private house 20 provided with a user node C exists in vicinity of the stop point 14b. A school 22 provided with a user node D exists in vicinity of the stop point 14f. A user node B is carried continuously by a student 24. Each of the user nodes A-D, by utilizing accordingly the fixed nodes L-T and the mobile nodes W-Z described above carries out a data communication (packet communication).

To each of the mobile nodes, service information of the regularly operating bus mounting itself is set. Also to each of the fixed nodes, service information of the regularly operating bus mounting the mobile node which carries out (links) a direct data communication is set.

In other words, to the mobile node W and X's IDs “L”, “M”, “N” and “P” of the mobile nodes provided along the first route Rt1 are set as service information. To the mobile node Y and Z's IDs “P”, “Q”, “R”, “S” and “T” of the mobile nodes provided along the second route Rt2 are set as service information.

On the other hand, to the fixed nodes L-M, a time table of the regularly operating buses 12a and 12b traveling the first route Rt1 and an after-link route table listing in order of service the IDs of the other fixed nodes provided on the first route Rt (in regard to fixed node L, “M”, “N” and “P”) are set as service information. The after-link route table also includes a move time to each fixed node (in regard to the fixed node L, move time to the fixed node M, N and P). To each of fixed nodes P-T set are; a time table of the regularly operating buses 12c and 12d traveling the second route Rt2; and the after-link route table listing in order of service the IDs of the other fixed nodes (in regard to fixed nodes R, “P”, “Q”, “S” and “T”) provided on the second route Rt as service information. Also on this after-link route table included is a move time to each of fixed nodes (in regard to the fixed node R, move time to the fixed nodes P, Q, S and T).

Each of the user nodes makes a registration of a desired temporary ID (destination node ID) to the fixed node within a network area. For example, the user node C provided in the private house 20 makes a registration of the temporary ID “CM” to the fixed node M in the stop point 14b, and the user node D provided in the school 22 makes a registration of the temporary ID “DR” to the fixed node R in the stop point 14f. The user node B able to move freely makes a registration of the temporary ID “BL” to the fixed node L in the stop point 14a, and in addition makes a registration of the temporary ID “BR” to the fixed node R in the stop point 14f.

On the other hand, as the user node A provided in the store 18 is located outside the network area of the fixed node L in the stop point 14a, it is impossible to make a direct communication with the fixed node L. In other words, it is necessary for the user node A to have the user node B relay a packet signal destined to itself. Due to this, the user node A associates the temporary ID “BL” of the user node B registered in the fixed node L with the ID “A” of itself.

Explanations as to a concrete operation of a packet transfer are subsequently given. For example, when the student 24 makes an individual sending of a packet signal from the vicinity of the stop point 14a to the private house 20, the user node B using the temporary ID “CM” registered in the fixed node M as a destination node ID, and creates a packet signal using the ID “M” of the fixed node M as a base node ID. The created packet signal also includes an identifier showing an “individual sending”. The user node B refers the created packet signal to the fixed node L, the entrusted fixed node L, based upon the service information set to itself and the base node ID's “M” specifies a mobile node able to deliver the packet signal to the fixed node M in the shortest time. If the specified mobile node is a mobile node W, the packet signal is transferred from the fixed node L to the mobile node W when the regularly operating bus 12a stops the stop point 14d.

The mobile node W specifies a fixed node to which the packet signal is handed over, based upon the base node ID “M” included in the transferred packet signal and the service information set to itself. When the regularly operating bus 12a arrives at the stop point 14b, the packet signal is entrusted to the fixed node M. The fixed node M sends the packet signal to the user node C based upon the destination node ID “CM”, and this completes the packet communication.

When the student 24 makes an individual sending of the packet signal to the school 22, the destination node ID included in this packet signal is “DR” and the base node ID is “R”. At this time, the fixed node L which received the packet signal from the user node B is unable to discover the same fixed node ID as the base node ID from service information set to itself. In this case, the fixed node L then transfers the packet signal to an inquiry destination mobile node set in advance. The inquiry destination mobile node is the mobile node W, and when the regularly operating bus 12a arrives at the stop point 14a, the packet signal is transferred from the fixed node L to the mobile node W.

However, the base node ID “R” is not set to the service information provided in the mobile node W, and the mobile node W transfers the packet signal to the inquiry destination fixed node. In the mobile node W, the fixed node P is set as the inquiry destination fixed node, and the packet signal is handed over to the fixed node P when the regularly operating bus 12a arrives at the stop point 14d. As the fixed node P has the base node ID “R” in the service information, the packet transfer is hereinafter carried out according to the above described manner.

In other words, the fixed node P, based upon the destination node ID and the service information specifies the mobile node able to deliver the packet signal to the fixed node P in the shortest time (for example, specifies the mobile node Y), and entrusts the packet signal to the mobile node W when the regularly operating bus 12c arrives at the stop point 14d. The fixed node R receives the packet signal from the mobile node Y when the regularly operating bus 12c arrives at the stop point 14f, and the received packet signal is transferred to the user node D based upon the destination node ID “DR”. This completes the packet communication.

If the destination of the packet signal of individual sending sent by the student 24 is a node within another communication network connected to the terminal 16, the fixed node P is unable to specify the base node ID, either. However, to the fixed node P, the mobile node W moving along the first route Rt1 and the mobile node Z moving along the second route Rt2 are set as the inquiring destination mobile node. Due to this, the fixed node P entrusts the packet signal received from the mobile node W to the mobile node Z (node other than the mobile node W) when the regularly operating bus 12d stops at the stop point 14d. In the mobile node Z set are the fixed node P and T as the inquiry destination fixed node, and the mobile node Z hands over the packet signal to the fixed node T (node other than the fixed node P) when the regularly operating bus 12d arrives at the terminal 16. In this way, the packet signal transferred to the fixed node T is sent to the destination node by way of another communication network.

When the individual sending of the desired packet is made from the private house 20 to the store 18, the user node C uses the ID “A” of the user node A as a destination node ID, and in addition creates the packet signal using the ID “L” of the fixed node L as a base node ID, and then the created packet signal is entrusted to the fixed node M. Although the entrusted packet signal is transferred to the fixed node L based upon the base node ID “L”, the user node A is located outside the network area of the fixed node L, thus unable to make a direct sending of the packet signal to the user node A. It is noted that the ID “A” of the user node A is registered in a hierarchical lower level of the temporary ID “BL” of the user node B. Due to this, the fixed node L entrusts a packet signal relay destined to the user node A to the user node B when the student 24 stops at the stop point L. The packet signal entrusted to the user node B is transferred to the user node A when the student 24 visits the store 18. This completes the packet communications.

When the individual sending of the packet signal is made when the student 24 rides the regularly operating bus 12a, the packet signal is first entrusted to the mobile node W. The entrusted packet signal is handed over to the fixed node P (inquiry destination fixed node) when the regularly operating bus 12a stops at the stop point 14d. The fixed node P transfers the packet signal to the mobile node Y or Z when the regularly operating bus 12c or 12d stops at the stop point 14d. The transferred packet signal is subsequently transferred to the user node D of the school 22 by way of the fixed node R in the stop point 14f.

When the individual sending of the packet signal is made from the private house 20 to the student 24. The destination node ID “BL” and the base node ID “L”, or the destination node ID “DR” and the base node ID “R” are set to the packet signal. The fixed node M in the stop point 14b receives such the packet signal from the user node C of the private house 20, and the received packet signal is entrusted for example to the mobile node W of the regularly operating bus 12a. Now, if the student 24 rides the regularly operating bus 12a, and on condition that its own temporary ID “BL” and “DR” are temporarily registered (with a limited time), the packet signal is transferred from the mobile node W to the user node B. In other words, the packet signal is directly handed over to the user node B without being transferred to the fixed node L or R.

In regard to a kind of packet signals, in addition to the above individual sending packets to be sent to the specific node, there is also a broadcast transmission packet to be transmitted to an unspecified multiplicity of nodes. An identifier to show a “broadcast transmission” instead of the “individual sending” is set to this broadcast transmission packet. Similar to the individual sending packet, included in the packet are the destination node ID and the base node ID.

When the temporary ID “DR” of the user node D is set as the destination ID, and the ID “R” of the fixed node R is set as the base node ID, the packet signal is broadcast-transmitted after being transferred to the user node D. The broadcast-transmitted packet signal is transferred to an unspecified multiplicity of nodes located in the neighborhood of the school 22, and the broadcast relay is subsequently carried out.

When the ID “Q” of the fixed node Q is set as the destination node ID and the base node ID, the packet signal is broadcast-transmitted after being transferred to the fixed node Q. The broadcast-transmitted packet signal is broadcast-relayed by way of an unspecified multiplicity of nodes located on the periphery of the stop point 14e.

When the ID “X” of the mobile node X is set as the destination node ID and the base node ID, the packet signal is broadcast-transmitted after being transferred to the mobile node X. The broadcast-transmitted packet signal is broadcast-relayed by way of the user nodes and the like carried by passengers of the regularly operating bus 12b.

It is noted that in the packet signal (broadcast relay packet) to be broadcast-relayed after the broadcast transmission, only the identifier of the “broadcast relay” is included, and the destination ID and the base node ID are not included.

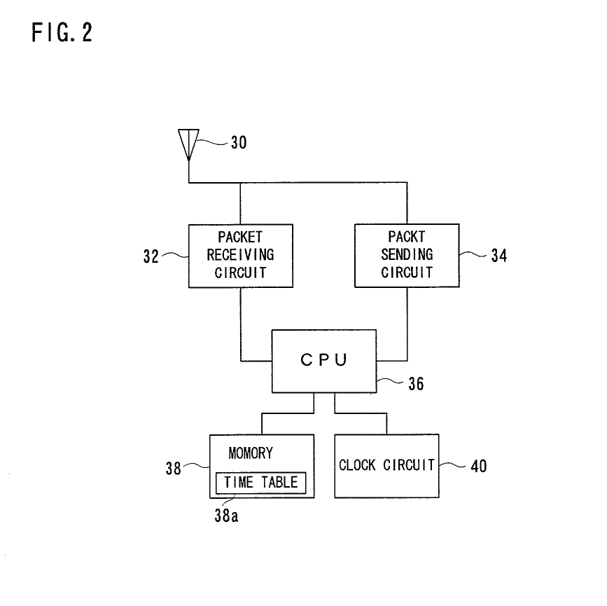

All of the user node A-D, the fixed node L-T and the mobile node W-Z are constituted as shown in FIG. 2. When a high frequency packet signal is trapped by an antenna 30, the trapped high frequency packet signal is demodulated into a base band by a packet receiving circuit 32. The demodulated packet signal is applied to a CPU 36, and a predetermined process is carried out. When the base band of the packet signal is created by the CPU 36, the created packet signal is modulated into a high frequency by the packet sending circuit 34. The modulated high frequency packet signal is transmitted by way of the antenna 30. A clock circuit 40 is used to detect a present time, and it will be sufficient if provided in the fixed node L-T.

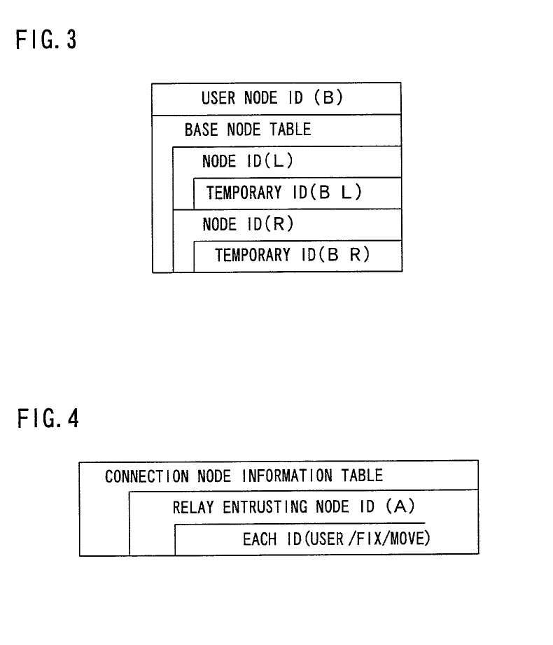

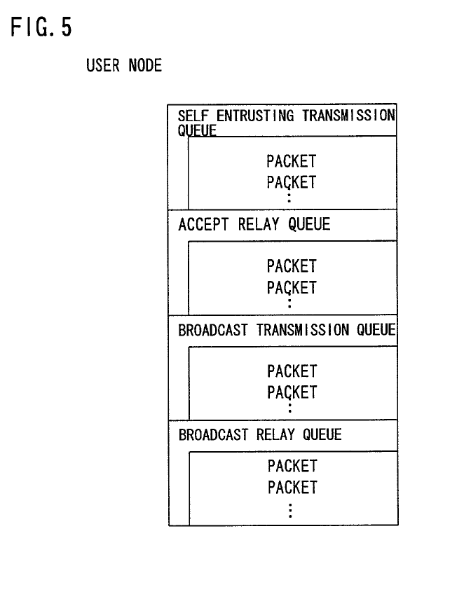

In a memory 38 of the user node A-D, a profile data as shown in FIG. 3 and a connection node information table as shown in FIG. 4 are stored, and in addition a packet storage area as shown in FIG. 5 is formed.

FIG. 3 shows a profile data of the user node B. At the top, the user node ID “B” is set. A base node table is subsequently formed. To the base node table set are an ID of a node which the user node B uses as a base, and a temporary ID of a user node registered at each base. As the student 24 lives in the neighborhood of the stop point 14a, and goes to the school 22, the base node table has the ID “L” of the fixed node L, and the temporary ID “BL” registered in the fixed node L, in addition the ID “R” of the fixed node R and the temporary ID “BR” registered in the fixed node R.

FIG. 4 shows a connection node information table of the user node B, and an ID of a user node to which the relay is entrusted is set to the connection node information table. Although the user node A in the store 18 is unable to exchange data with the fixed node L, the student 24 visits the store 24 at frequent intervals. Due to this, when the user node B takes over the relay of the packet signal destined to the user node A, the user node ID “A” is set to the connection node information table as a relay entrusting node ID.

FIG. 5 shows a packet storage area of the user node B, and this area includes a self-entrust transmission queue, an accept relay queue, a broadcast transmission queue and a broadcast relay queue. The self-entrust transmission queue stores the packet signal created by the user node B to which the node ID destined to other than itself is set. In other words, provided that the packet signal is destined to other user nodes, not only the individual sending packet but also the broadcast transmission packet are stored in this queue. In the accept relay queue stored is the packet signal which is entrusted to relaying to other nodes. When the user node B receives the packet signal destined to the user nod A from the fixed node L, the received packet signal is stored in the accept relay queue. In the broadcast transmission queue stored is the packet signal created by the user node B, and in addition directly broadcast-transmitted from the user node B. Such a broadcast transmission packet precludes the destination ID and the base node ID. In the broadcast relay queue stored is the packet signal which is broadcast-transmitted from other nodes and is entrusted to relaying. The packet signal including an identifier of the “broadcast relay” is stored in this queue.

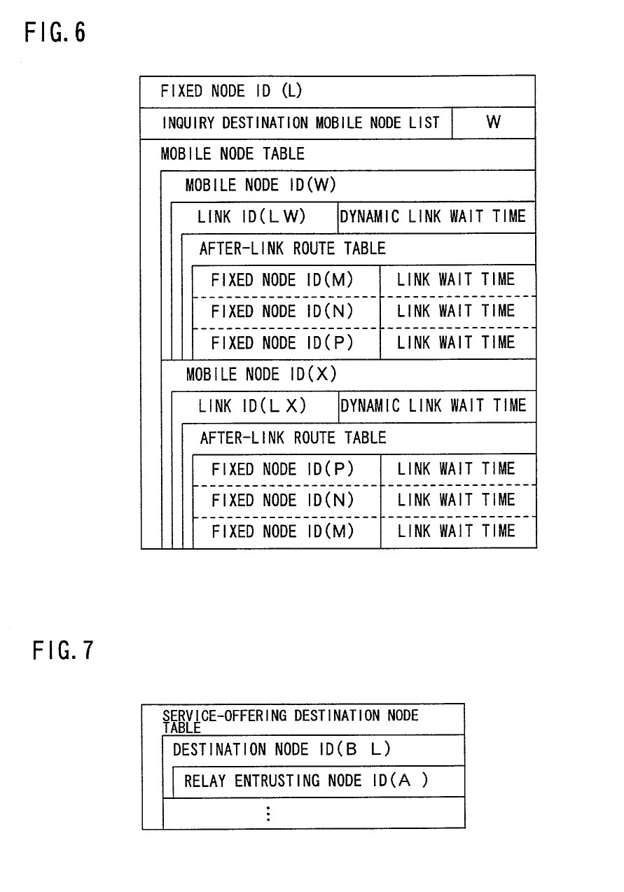

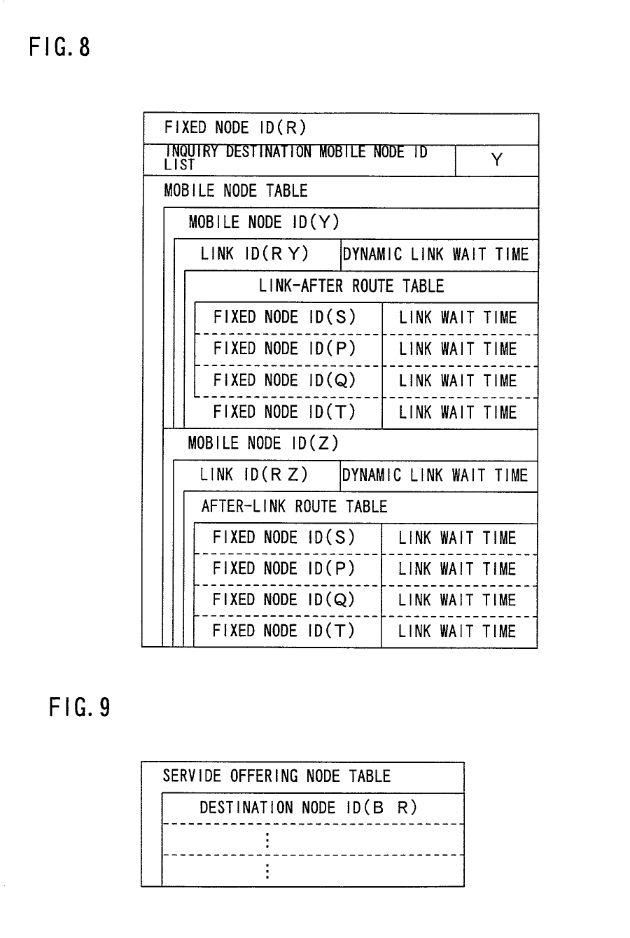

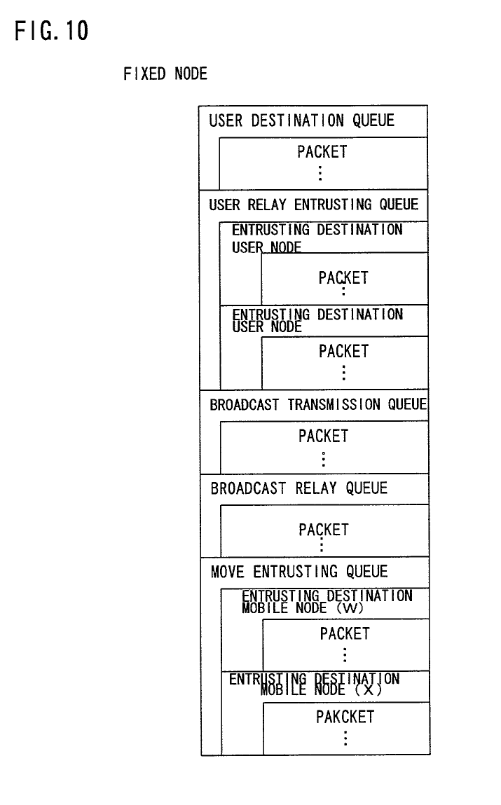

In a memory 30 of the fixed node L-T, a profile data shown in FIGS. 6 and 8 and a service-offering destination node table as shown in FIGS. 7 and 9 are stored. In addition, the packet storage area shown in FIG. 10 is formed. In the memory 38, stored is the timetable 38a of the regularly operating bus to which the mobile node to carry out a direct data communication is set. In other words, in the memory 38 of the fixed node L-P the time table 38a of the regularly operating bus 12a and 12b is stored, and in the memory 38 of the fixed node P-T the time table of the regularly operating bus 12c and 12d is stored.

FIG. 6 shows a profile data of the user node L. At the top of the profile data set is the fixed node ID “L”, and an inquiry destination mobile node ID list is subsequently formed. This list is to list IDs of the mobile nodes which act as a destination of the packet signal whose destination is unknown. According to FIG. 6 the mobile node ID “W” is the inquiry destination mobile node. The fixed node L transfers the received main packet signal upon assuming to be a destination unknown packet signal when the base node ID held by the received main packet signal shows neither the fixed node L-P nor the mobile node W nor X.

Following the inquiry destination mobile node ID list a mobile node table is formed. On this table written are IDs of the mobile nodes “W” and “X” each of which exchanges the packet signal with itself (fixed node L), and to each of the mobile node IDs “W” and “X” assigned are a link ID, a dynamic link wait time and an after-link route table. The link ID is used in order for each of the fixed nodes and the mobile nodes to specify a communication opponent. The link ID between the fixed node L and the mobile node W is rendered “LW”, and the link ID between the fixed node L and the mobile node X is rendered “LX”.

The dynamic link wait time means a required time for each of the mobile node W and X (in other words, the regularly operating bus 12a and 12b) to arrive at the fixed node L (in other words, the stop point 14a), and is calculated based upon the present time shown by the clock circuit 40 and the time table of the regularly operating bus 12a and 12b. The dynamic link wait time changes progressively.

On the after-link route table listed are the IDs of the fixed nodes with which each of the mobile nodes W and X makes a communication (establish a link) following the fixed node L in order of routes, and in addition a wait time which ranges from a release of the fixed node L to forming a link with each of the fixed node is linked with each ID.

As the regularly operating bus 12a provided with the mobile node W stops at the stop points in order of 14b→14c→14d, on the after-link route table corresponding to the mobile node W, each fixed node ID is written in order of M→N→P. If the time spent for the regularly operating bus 12a to reach from the stop point 14a, to the stop point 14b, 14c and 14d is three minutes, five minutes and eight minutes, the wait time assigned to each of the fixed node ID “M”, “N” and “P” is rendered “three minutes”, “five minutes” and “eight minutes” respectively.

On the other hand, as the regularly operating bus 12b provided with the mobile node X stops at the stop point in reverse order of the regularly operating bus 12a (in order of 14d→14c→14b), On the after-link route table corresponding to the mobile node X, each fixed node ID is set in order of P→N→M. If the time spent for the regularly operating bus 12b to reach from the stop point 14a to the stop point 14d, 14c, and 14b is two minutes, five minutes and seven minutes, the wait times of “two minutes”, “five minutes” and “seven minutes” are repeatedly assigned to the fixed nodes ID “P”, “N” and “M”.

FIG. 7 shows the service-offering destination table of the fixed node L. To this, the temporary ID of the user node which uses the fixed node as a base is registered as the destination node ID, and in addition the ID of the user node which entrusted the relay to the user node which registered is registered as the relay entrusting node ID. As the user node B uses the fixed node L as the base, the temporary ID “BL” is registered as the destination node ID. Furthermore, as the user node A entrusts the relay to the user node B, the user node ID “A” is registered in a hierarchical lower level of the temporary ID “BL” as the relay entrusting node ID.

FIG. 8 shows a profile data of the fixed node R. At the top of this profile data the fixed node ID “R” is set, and to the inquiry destination mobile node ID list the mobile node ID “Y” is set. The fixed node R transfers the received packet signal to the mobile node Y upon assuming it to be a destination unknown packet when the base node ID held by the received packet signal shows neither the fixed node P-T nor the mobile node Y nor Z (for example, when showing the fixed node L).

In the mobile node table written are the IDs of the mobile node “Y” and “Z” each of which exchanges the packet signal with itself (fixed node R). The link IDs “RY” and “RZ” are respectively assigned to the mobile node ID “Y” and “Z” assigned are, and in addition the dynamic link wait time calculated based upon the timetable and the present time and the predetermined after-link route table are assigned each of the mobile node ID “Y” and “Z”.

The operating route of the regularly operating bus 12c provided with the mobile node Y and the regularly operating bus 12d provided with the mobile node Z is mutually identical, except for the timetable. In other words, both the regularly operating bus 12c and 12d stop at each stop point and terminal in order of 14g→14f→14d→14e→16→14e→14d. Due to this, on the after-link route table corresponding to the mobile node Y, the fixed node IDs are written in order of S→P→Q→R. As understood from FIG. 8, its own ID (fixed node R) is never written on the after-link route table. Furthermore, no IDs other than itself numbering more than two are written, either. Similar to the above description, the times spent for the regularly operating bus 12c to reach from the stop point 14d to the stop point 14g, 14d, 14e and to the terminal 16 are respectively assigned to the fixed IDs.

On the service-offering table shown of the user node R in FIG. 9, the temporary ID using the fixed node R as a base is set. As the user node B also uses the fixed node R as the base, the temporary ID “BR” is stored on the service-offering table as the destination ID.

It is noted that the fixed node P varies from other fixed nodes in that the fixed node P lies across both the first route Rt1 and the second route Rt2. Due to this, on the inquiry destination mobile node list formed in the profile data of the fixed node P listed are the mobile node W moving along the first route Rt1 and the mobile node Z moving along the second route Rt2. Furthermore, a link ID, the dynamic link time and the after-link route table regarding all the mobile nodes W-Z, are provided on the mobile node table.

FIG. 10 shows the packet storage area of the fixed node L. This area includes a user destination queue, a user relay entrusting queue, a broadcast transmission queue, a broadcast relay queue and a mobile entrusting queue. In the user destination queue stored is the packet signal (including broadband transmission packet) where the base node ID indicates itself (fixed node L), and the destination ID is in agreement with the temporary ID which registered to itself (fixed node L). The packet signal destined to the user node B is stored in this queue. In the user relay entrusting queue stored is the packet signal where the base node ID indicates itself (fixed node L), and the destination node ID is in agreement with the relay entrusting node ID which registered to itself (fixed node L). The packet signal destined to the user node A is stored in this queue.

In the broadcast transmission queue stored is the packet signal which both of the base node ID and the destination node ID show itself (fixed node L), and in addition whose identifier shows “broadcast transmission”. In the broadcast relay queue stored is the packet signal whose identifier shows “broadcast relay”. The packet signals broadcast-transmitted from other nodes are stored in this queue.

In the mobile entrusting queue the packet signal entrusting to the mobile node is stored. It is noted that the mobile entrusting queue is divided for each mobile node, and the packet signal is stored in a column corresponding to the mobile node determined as the entrusting destination. In other words, in the mobile entrusting queue of the fixed node L the columns of the mobile node W and the mobile node X are provided. The packet signal using the mobile node W as the entrusting destination is stored in the column of the mobile node W, and the packet signal using the mobile node X as the entrusting destination is stored in the column of the mobile node X.

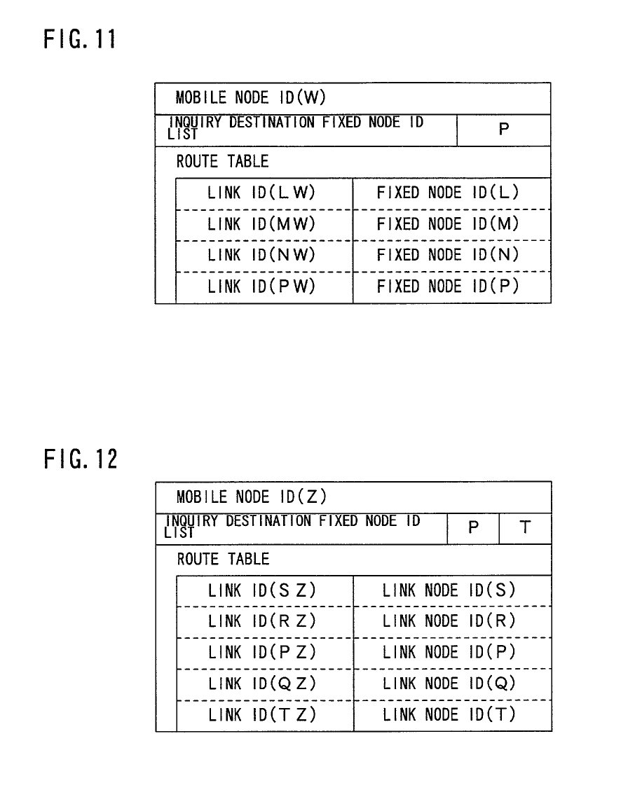

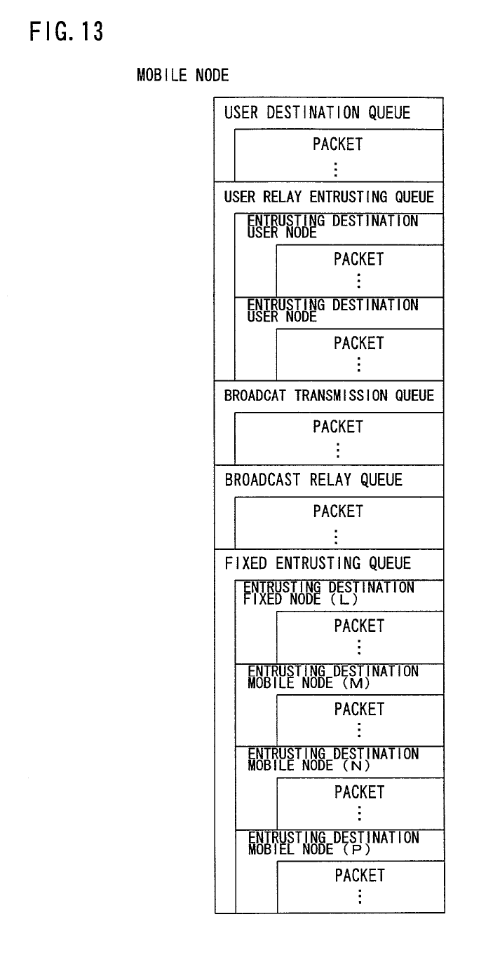

In the memory 38 of the mobile node W-Z, a profile data shown in FIGS. 11 and 12 is stored, and a packet storage area shown in FIG. 13 is formed.

FIG. 11 represents a profile data of the mobile node W. At the top the mobile node ID “W” is set. The inquiry destination node ID list is subsequently formed. If the destination of the received packet signal is unknown, in other words, the base node ID of the packet signal does not show either the fixed nodes L, M, N and P linked with itself (mobile node W), the received main packet signal is transferred to the fixed node of the inquiry destination fixed node ID list. According to FIG. 11, as the fixed node P is the inquiry destination node, for example the packet signal including the base node ID “R” is transferred to the fixed node P.

On the route table set are the link IDs “LW”, “MW”, “NW” and “PW” of the fixed node L-P linked with the mobile node W, and to each of the link IDs assigned are the corresponding fixed node ID “L”, “M”, “N” and “P”. The link ID and the fixed node ID are set on the route table in the order in which the mobile node W links, and updated every time the mobile node W releases the link with each of the fixed nodes L-P (every time the regularly operating bus 12a leaves each of the stop points 12a-14d). Due to this, immediately after the regularly operating bus 12a leaves the stop point 14d, each of the link IDs is lined in order of LW→MW→NM→PW as shown in FIG. 9.

FIG. 12 shows a profile data of the mobile node Z. Similar to FIG. 11, at the top “Z” of the ID of the mobile node Z is set. The inquiry destination node ID and the route table are subsequently formed. It is noted that according to FIG. 12, two IDs “P” and “T” are set to the inquiry destination node ID list, and the route table of FIG. 12 represents a state of the regularly operating bus 12d leaving the stop point 14f on the way to the stop point 14g.

FIG. 13 shows a packet storage area of the mobile node W. This area includes a user destination queue, a user relay entrusting queue, a broadcast transmission queue, a broadcast relay queue and a fixed entrusting queue. In the user destination queue the packet signal (including the broadcast transmission packet) destined to the user node which registers itself(mobile node W) as the temporary base is stored. When the student 24 rides the regularly operating bus 12a, and registers the temporary ID “BL” and “BR” of itself to the mobile node W, in the case that the mobile node W receives the packet signal including the user destination node ID “BL” and “BR”, the received packet signal is stored in the destination queue. The received packet signal is subsequently transferred to the user node B without delay.

In the user relay entrusting queue stored is the queue the packet signal destined to an user nodes transferred by way of the user node registering itself (mobile node W) as the temporary base. For example, if the student rides the regularly operating bus 12a, and temporarily registers the temporary ID “BL” and the entrusting relay node ID “A”, the packet signal having the destination node ID “A” is stored in the user relay entrusting queue. This packet signal is subsequently transferred to the user node B.

In the broadcast transmission queue, similar to above stored is the packet signal in which the base node ID and the destination node ID agree with itself (mobile node W), in addition, whose identifier shows “broadcast transmission”. In the broadcast relay queue stored is the packet signal broadcast-transmitted from an node, and whose identifier shows the “broadcast relay”.

In the fixed entrusting queue the packet signal which is entrusted to the fixed node is stored. The fixed entrusting queue is also divided for each of the fixed nodes, and the packet signal is stored in the column corresponding to the fixed node of the entrusting destination. In the fixed entrusting queue of the mobile node W, columns of the fixed nodes L, M, N and P are formed. For example, the packet signal using the fixed node L as the entrusting destination is stored in the column of the fixed node L.

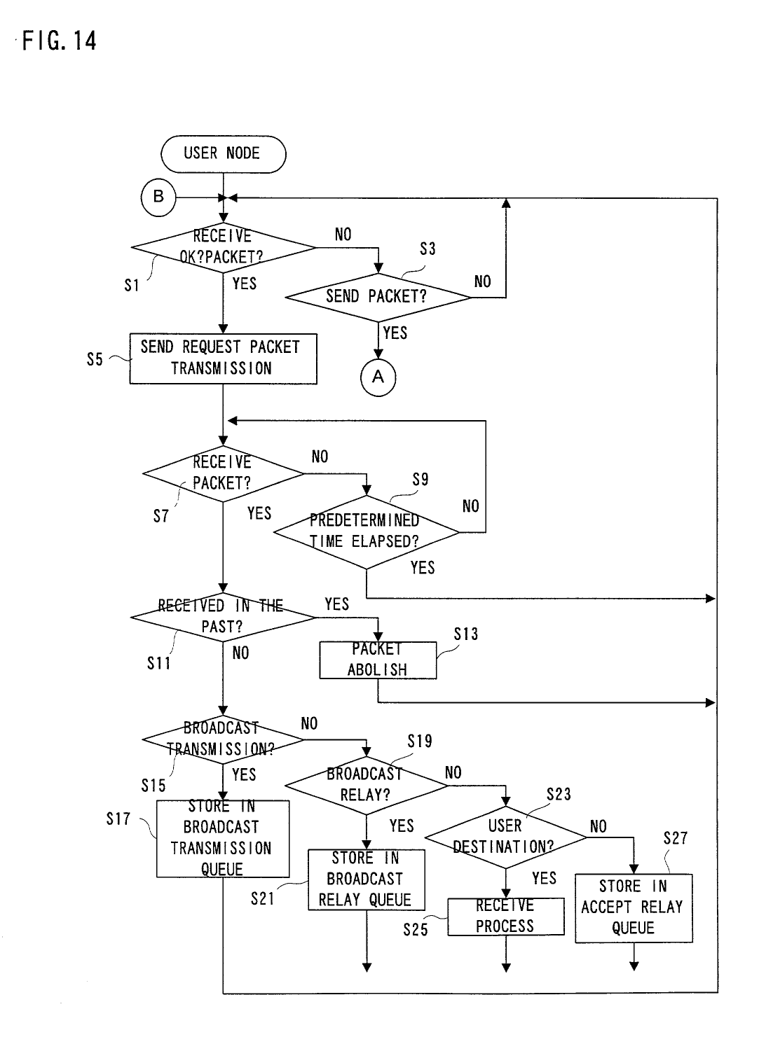

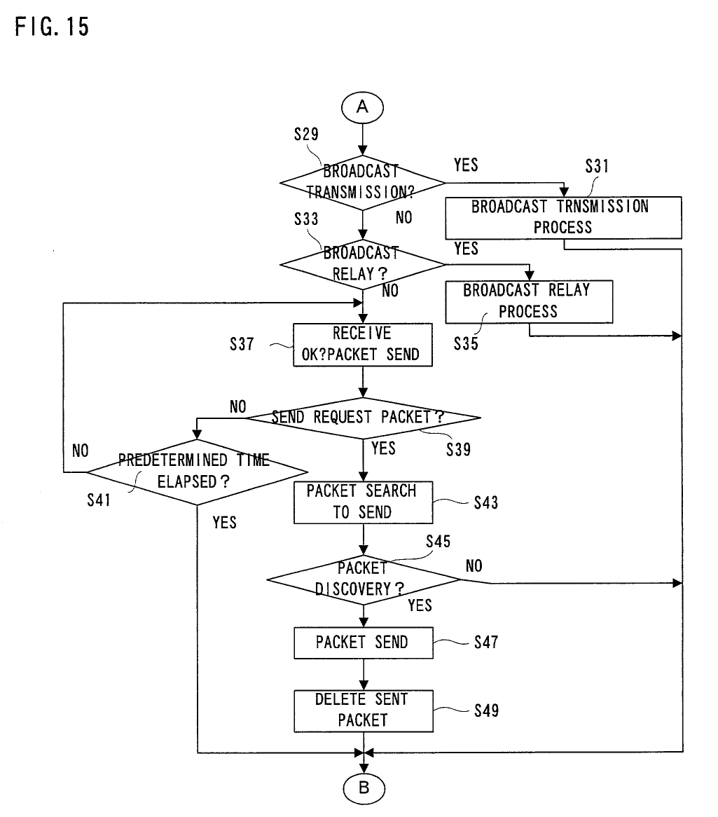

The CPU 36 provided in each of the user nodes A-D processes flowchart shows FIGS. 14 and 15. In step S1 it is determined whether or not a receive OK? packet signal is received. The receive OK? packet signal is a signal to request other nodes to receive, and although the signal has a send source ID, it does not have a destination node ID. Upon receipt of the receive OK? packet signal, the process proceeds to step S5, and a send request packet signal including a node ID of itself and a node ID of an opponent(send source ID) is sent. In step S7 it is determined whether or not a packet signal including communication data (hereinafter entrusted to as a “main packet signal”) is received from a node of the opponent. If the main packet signal is not received, in step S9 determined is whether or not a required time is elapsed, and if NO the process repeats the step S7. However, if Yes the process returns to the step S1.

Upon receipt of the main packet signal from the node of the opponent before the required time elapses, the process proceeds from the step S7 to step S11, and then it is determined whether or not the received main packet signal is the same main packet signal as received in the past. As there is a possibility that the same main packet signal is repeatedly received in case of a broadcast relay, a process as in the step S11 is carried out in order to avoid a traffic congestion caused by a re-relay of the same main packet signal.

If YES in the step S11, the process proceeds to step S13, after abandoning the received main packet signal, and the process returns to the step S1. On the other hand, if NO in the step S11 determined are a kind of the received main packet in step S15, step S19 and step S23 respectively. If the received main packet signal has the temporary ID of itself as the destination node ID, and in addition its identifier shows “broadcast transmission”, the process proceeds from the step S15 to step S17. The received main packet signal is then stored in the broadcast transmission queue. If the received main packet signal does not have a destination node ID, and the identifier shows “broadcast relay”, the process proceeds from the step S19 to step S21. The received main packet signal is then stored in the broadcast relay queue. If the received main packet signal has the temporary ID of itself as the destination node ID, and the identifier shows “individual sending”, the process proceeds from the step S23 to step S25, and then a receiving process is carried out. If the received main packet signal has a relay entrusting node ID set in a connection node information table shown in FIG. 4, and in addition the identifier shows “individual sending”, the process proceeds from the step S23 to step S27. The received main packet signal is then stored in the accept relay queue.

If NO is determined in the step S1 the process proceeds to step S3, and determined is the presence of the main packet signal to be sent. If no main packet signal is stored in the packet storage area shown in FIG. 5, the process returns to the step S1. However if even one is stored, YES is determined in the step S3, and in step S29 and S33 determined is in what queue the main packet signal to be sent is stored. If a storage destination is the broadcast transmission queue, the process proceeds from the step S29 to step S31, and broadcast transmission process is carried out. On the other hand, if the storage destination is the broadcast relay queue, the process proceeds from step S33 to step S35, and a broadcast relay process is carried out.

When the packet signal is stored in the self-entrust transmission queue or the accept relay queue, the process proceeds from the step S33 to step S37, and the receive OK? packet signal including the node ID of itself is sent. If no send request packet signal is sent back from the neighboring nodes in response to the receive OK? packet signal, the process proceeds from step S39 to step S41, and determined is whether the required time is elapsed. If NO, the process repeats the step S37 and the step S39. If YES, the process returns the step S1. If the send request packet signal is received in the required time, the process proceeds to step S43, and then searches the main packet signal to be sent to the transmission source node based upon the send source ID of the received send request packet signal.

In step S45 it is determined whether or not the main packet signal to be sent is discovered. When the transmission source ID shows a mobile node or a fixed node, and in addition the main packet signal created by itself is stored in the self-entrust transmission queue, YES is determined in the step S45. If the relay entrusting node ID set in the connection node information table shown in FIG. 4 and the transmission source ID agree, and in addition the main packet signal destined to the transmission source ID is stored in the accept relay queue, determined is also YES in the step S45. If neither condition is applied, in the step S45 NO is determined.

If YES is determined in the step S45, along with sending the discovered main packet signal in step S47, in step S49 the main packet signal is deleted when the transmission is complete. Upon completing the step S49, the process returns to the step S1.

As processes above are carried out, for example, when the user node B receives the packet signal from the fixed node L, the received main packet signal is handled as follows in the user node B. If the packet signal is to be destined to the user node B, and in addition its identifier shows the “broadcast transmission”, the packet signal is once stored in the broadcast transmission queue in the step S17, and is subsequently broadcast-transmitted in the step S31. If the packet signal does not have the destination, and in addition its identifier shows the “broadcast relay”, this packet signal is stored in the broadcast relay queue in the step S21, and is subsequently broadcast-relayed in the step S33. If the packet signal is a signal using the user node B as the destination, and in addition its identifier shows the “broadcast transmission”, the packet signal is subjected to a receiving process in the step S25. If the packet signal is a signal using the user node A as the destination, and in addition its identifier shows “individual sending”, in step S27 this packet signal is then stored in the accept relay queue, and upon receipt of the sending request packet, is subsequently sent to the user node A in step S47.

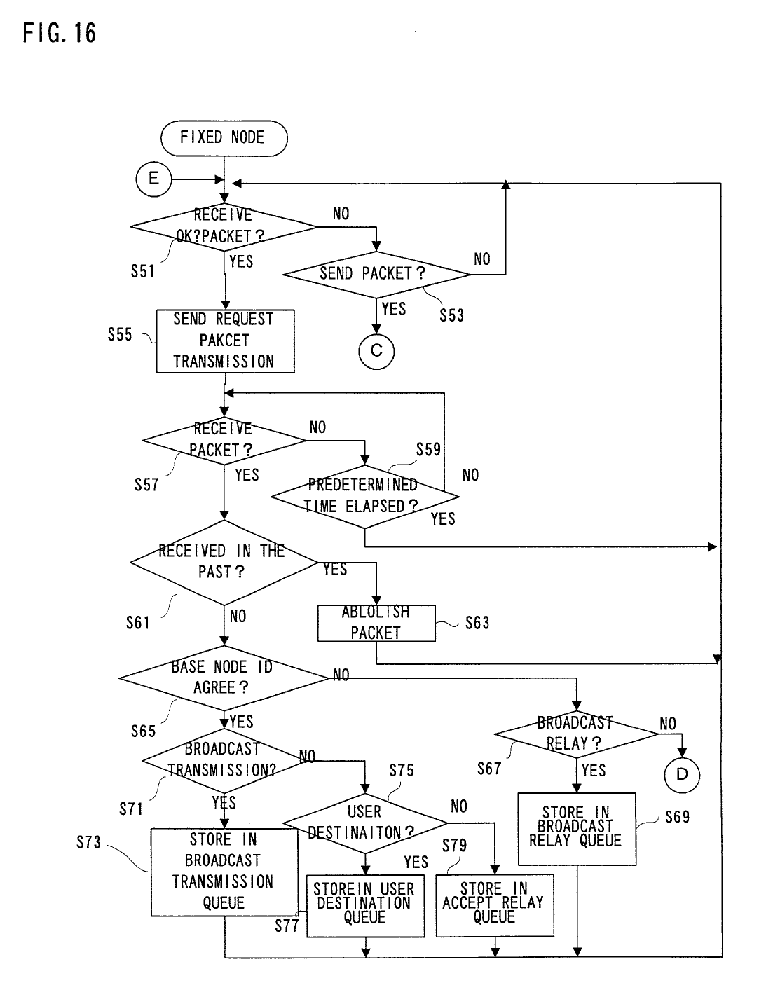

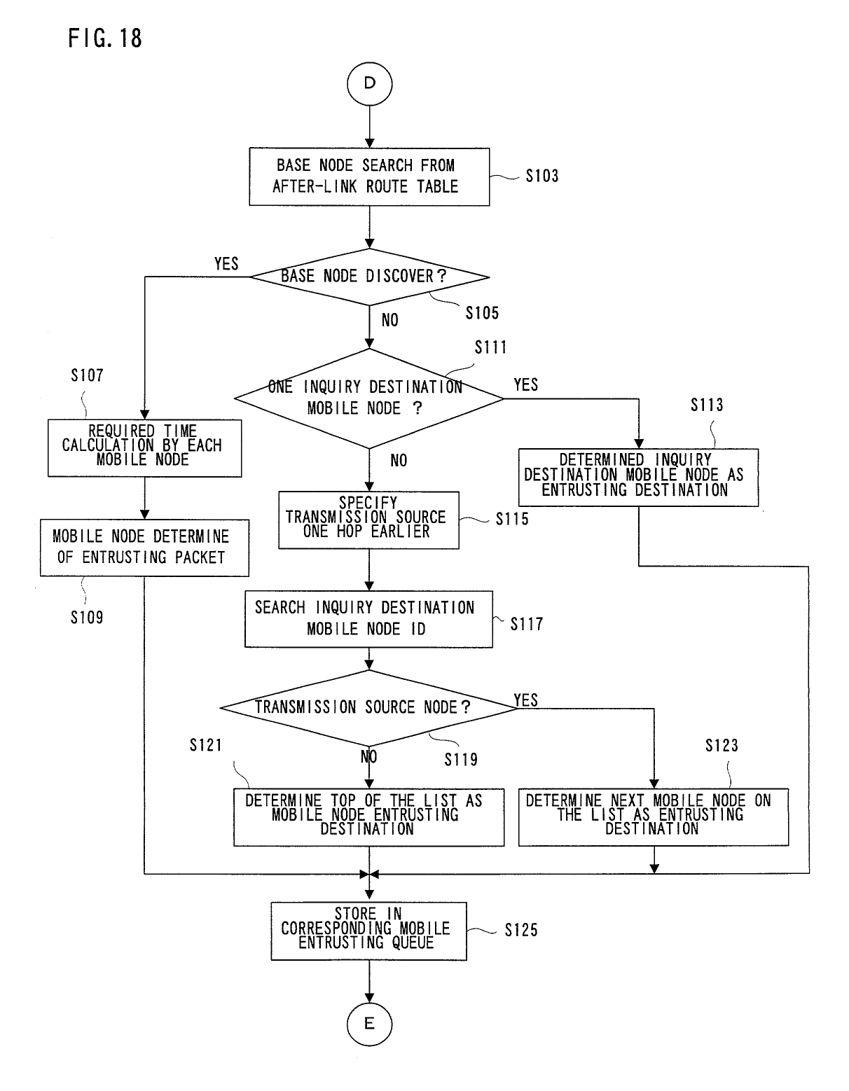

The CPU 36 provided at each of the fixed nodes L-T processes flowchart shown in FIG. 16 to FIG. 18. It is noted that in these processes, as the processes of steps S51 to S101s are almost similar to those of steps S1 to step S49 shown in FIGS. 14 and 15, duplicated descriptions are omitted wherever possible.

When the received main packet signal is determined as a new signal in the step S61, in the step S65 determined is whether or not the base node ID included in the received main packet signal agrees with the node ID of itself. As the base node ID is included in the main packet signal to be separately sent by comparing the base node ID and the ID of itself, the presence of agreement made between the both IDs is determined.

If the step S65 determines that both IDs agree, determined is made as to a kind of the received main packet signal in the step S71 and the step S73. If the destination node ID of the received main packet signal agrees with the node ID of itself, and in addition the identifier shows the “broadcast transmission”, YES is determined in the step S71. In the step S73 the received main packet signal is stored in the broadcast transmission queue. If the destination node ID of the received main packet signal agrees with the destination node ID (temporary ID) registered in the service-offering table shown in FIG. 7 and FIG. 9, in the step S75 YES is determined. In the step S77 the received main packet signal is stored in the user destination queue. If the destination node ID of the received main packet signal agrees with the relay entrusting node ID registered in the service-offering table, NO is determined in the step S75. In the step S79 the received main packet signal is stored in the accept relay queue.

If NO is determined in the step S65, in other words the base node ID included in the received main packet signal does not agree with the node ID of itself in the step S67, determined is whether or not the received main packet signal is the signal broadcast-transmitted. If the received main packet signal has neither the base node ID nor the destination node ID, and the identifier shows the “broadcast relay”, determined is YES in the step S67. In the step S69 the received main packet signal is stored in the broadcast relay queue. On the other hand the received main packet signal is not such a broadcast relay packet, processes following step S103 are carried out in order to refer to the received main packet signal to the mobile node.

Firstly in the step S103 searched for is the same fixed node ID (desired base node ID) as the base node ID included in the received main packet signal from the after-link route table represented in FIG. 6 and FIG. 8. In the succeeding step 105 determined is whether or not the desired base node ID is discovered. If YES, a required time is calculated depending on each node in step S107. As a plurality of mobile nodes are assigned to both the first route Rt1 and the second route Rt2, the required time for the received main packet signal to reach the desired base node differs. Due to this, in accordance with the timetable of each mobile node and the present time, the required time of each mobile node is calculated. In step S109 the mobile node which requires the shortest travel time is determined as the entrusting destination of the received main packet signal. In the successive step S125 the received main packet signal is stored in a predetermined section (section of a determined mobile node) as represented in FIG. 10. Upon completion of the step S125, the process returns to the step S51.

If the desired base node ID is not discovered, in the step S105 determined is No. In step S111 determined is the number of the mobile node IDs set as the inquiry destination mobile node ID list. As in the inquiry destination node ID list a plurality of mobile node IDs may be set (in the fixed node P list, the mobile node W and the mobile node Z are set), determining the number of IDs, and a process corresponding to the determination result is programmed to be carried out. If the inquiry destination mobile node ID is only one, the process proceeds from the step S111 to step S113, and the mobile node shown by this ID is determined to be the entrusting destination of the received main packet signal. When the entrusting destination node is determined, the process proceeds to step S125.

In the presence of a plurality of the inquiry destination mobile node IDs, the process proceeds from the step S111 to step S115, and a transmission source node of the received main packet signal is specified. In step S117 the specified transmission source node ID is searched from the inquiry destination mobile node list, and in the succeeding step S119 determined is whether or not the same mobile node ID as the transmission source node ID is discovered. In absence of the same mobile node ID, the process proceeds to step S121, and the mobile node shown by the first ID of the inquiry destination mobile node list is determined as the entrusting destination node of the received main packet signal. On the other hand, in the presence of the same mobile node ID as the transmission source ID, the process proceeds to step S123, and the ID next to the discovered ID is searched from the inquiry destination mobile node list, and the mobile node shown by the searched ID is determined as the entrusting destination node. Upon completion of the step S121 and the step S123, the process proceeds to the step S125.

As a result of the executions of the processes above, for example, if the fixed node L receives the main packet signal from the user node B, the received main packet signal is handled in the fixed node L as follows. If the base node ID included in the received main packet signal is “N”, it is possible to discover the same node ID from the after-link route table shown in FIG. 5. In this case, the required time for each mobile node W and X to deliver the received main packet signal from the fixed node L to the fixed node N is calculated. If the required time of the mobile node X is short, the received main packet signal is stored in the column of the mobile node X of the mobile entrusting queue, and is subsequently transferred to the mobile node X corresponding to the send request packet signal from the mobile node X.

On the other hand, if the base node ID included in the received main packet signal is “R”, it is not possible to discover the same ID from the after-link route table. In this case, the mobile node of the entrusting destination is determined by entrusting to the inquiry destination mobile node ID list. According to FIG. 5, as the mobile node “W” is set at the top of the inquiry destination mobile node, the received main packet signal is once stored in the column of the mobile node W of the mobile entrusting queue, and is transferred to the mobile node W corresponding to the send request packet signal from the mobile node W.

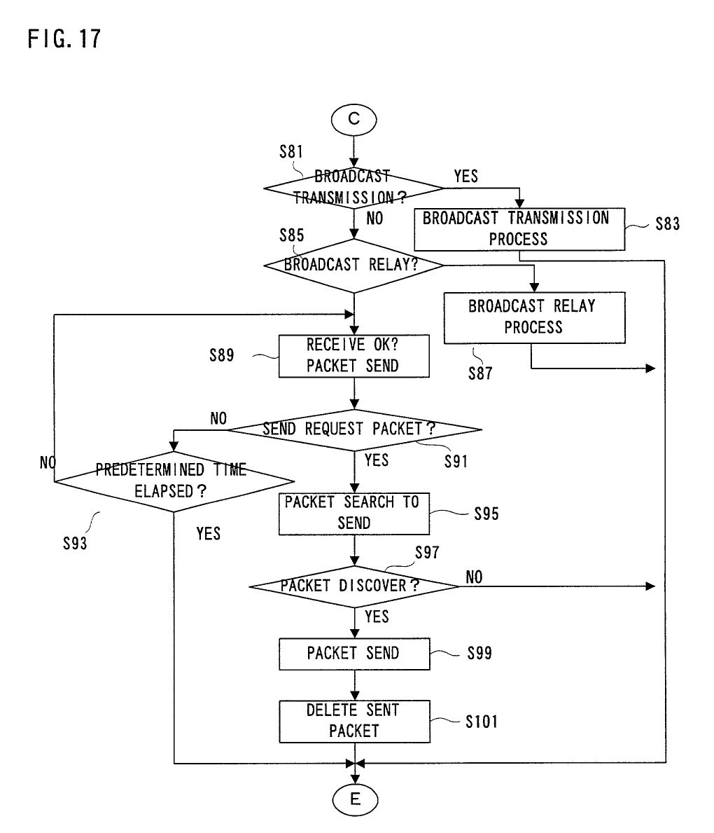

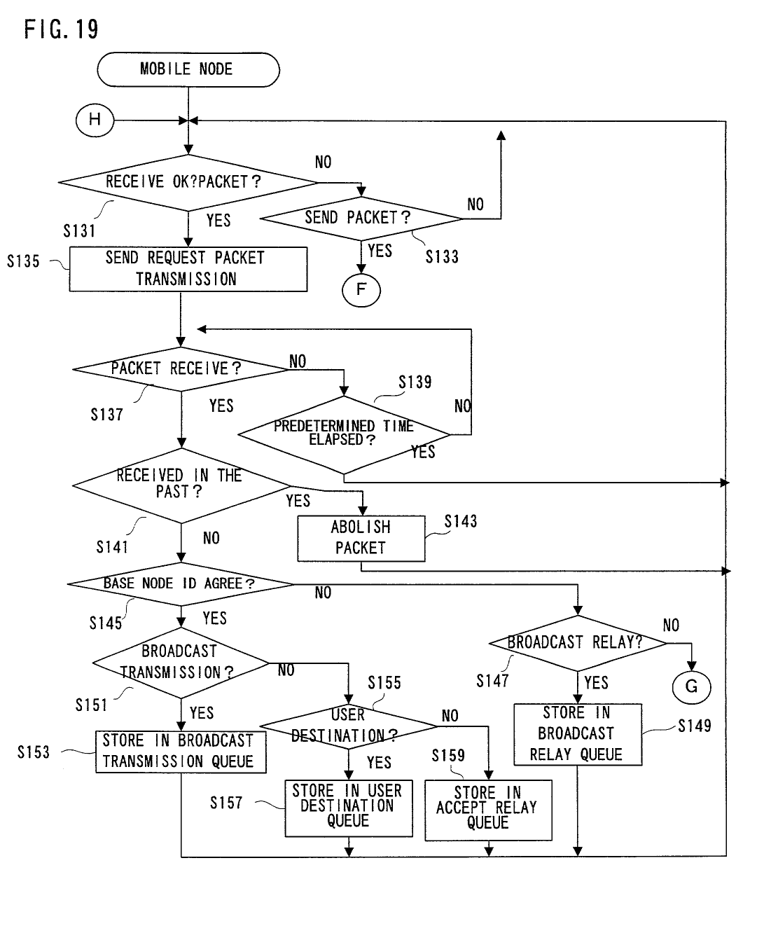

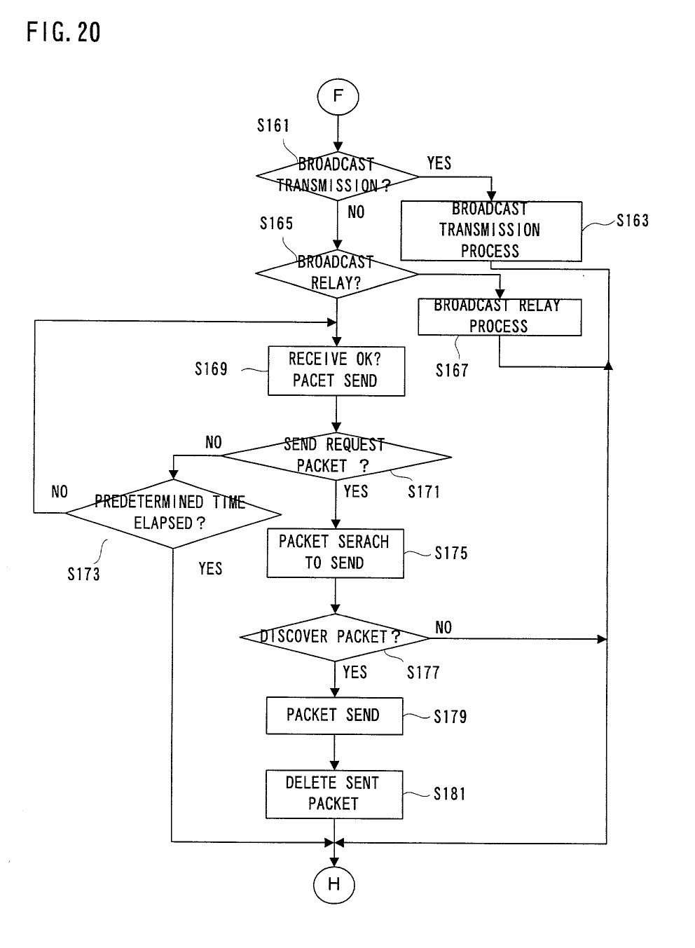

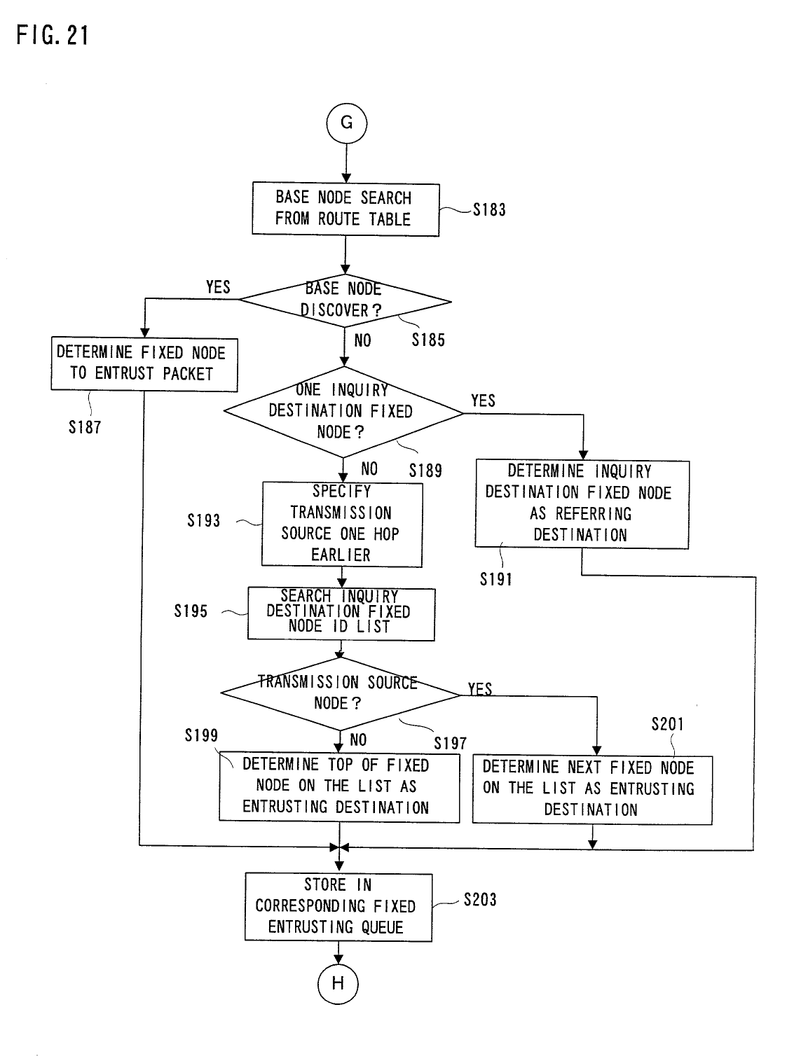

The CPU 36 provided at each of the mobile nodes W-Z processes flowchart shown in FIG. 19-FIG. 21. It is noted that as processes of step S131 - step S181 shown in FIG. 19 and FIG. 20 are similar to the processes shown in FIG. 16 and FIG. 17, only descriptions of FIG. 21 are herein given. In step S183 the same fixed node ID (desired base node ID) as the base node ID included in the received main packet signal is searched from the route table shown in FIG. 9 or FIG. 10. In the following step S185 it is determined whether or not the desired ID is found, and if YES the process proceeds to step S187. In the step S187 the fixed node ID shown by the found base node ID is determined as the entrusting destination node of the received main packet signal, and in step S203 the received main packet signal is stored in a predetermined column (a determined fixed node column) in a fixed entrusting queue shown in FIG. 13. Upon completion of the step S203, the process returns to the step S121.

In the absence of the desired base node ID, in the step S185 NO is determined, and in step S189 determined is the number of the fixed node IDs set to the inquiry destination fixed node ID list. If the inquiry destination fixed node ID is only one, in step S191 the fixed node shown by this ID is determined as the entrusting destination node of the received main packet signal. Upon determining the entrusting destination node, the process proceeds to the step S203.

In the presence of a plurality of the entrusting destination fixed node IDs, in step S193 the transmission source node (node of one hop earlier) of the received main packet signal is specified. In step S195 the specified transmission source node ID is searched from the inquiry destination fixed node ID list. In the following step S197 it is determined whether or not the same fixed node ID as the transmission source is found node ID from the list. In the absence of the same fixed node ID, the process proceeds to step S199, and then the fixed node shown by the top ID of the inquiry destination fixed node ID list is determined as the entrusting destination node of the received main packet signal. On the other hand, in the presence of the same fixed node ID as the transmission source ID, the process proceeds to step S201, and the ID next to the found ID is searched from the inquiry destination fixed node ID list. The searched ID is then determined as the entrusting destination node shown by the searched ID. Upon completion of the step S199 and the step S201, the process proceeds to the step S203.

As the result of the executions of the processes above, for example, when the mobile node W receives the main packet signal from the fixed node L, the received main packet signal is handle as follows in the mobile node W. If the base node ID included in the received main packet signal is “N”, it is possible to discover the same fixed node ID from the route table shown in FIG. 11. Due to this, the mobile node W determines the fixed node N as the entrusting destination node, and the received main packet signal is stored in the column of the fixed node N of the fixed entrusting queue. The stored received main packet signal is transferred to the fixed node N corresponding to the sent request packet signal from the fixed node N.

On the other hand, if the base node ID included in the received main packet signal is “R”, it is not possible to discover the same fixed node ID from the route table represented in FIG. 11. In this case, the fixed node of the entrusting destination is determined by entrusting to the inquiry destination fixed node ID list. According to FIG. 11, as the inquiry destination fixed node ID is only “P”, the received main packet signal is entrusted to the fixed node P when the mobile node W reaches the fixed node P. The main packet signal entrusted to the fixed node P is subsequently handed over to the mobile node Y or Z, and is transferred to the fixed node R when the mobile node Y or Z reaches the fixed node R.

For example, if the mobile node Z receives the main packet signal destined for the fixed node L from the fixed node R, the mobile node Z determines the entrusting destination of the received main packet signal by entrusting to the inquiry destination fixed node ID list shown in FIG. 12. According to FIG. 12 as the fixed node ID “P” is set at the top of the list, the mobile node Z entrusts the received main packet signal to the fixed node P upon reaching the fixed node P. The main packet signal entrusted to the fixed node P is subsequently brought to the fixed node L by the mobile node W or X.

Furthermore, for example, when the packet signal whose destination is a node of another network connected from the terminal 16 is entrusted from the fixed node S to the mobile node Z, the mobile node Z entrusts the received main packet signal to the fixed node P based upon the inquiry destination node ID list. However as the fixed node P is unable to specify the destination of the main packet signal, the received main packet signal is entrusted to the mobile node W based upon the inquiry destination mobile node ID list (at the top of the list, “W” is set). However, the mobile node W is not able to specify the destination of the main packet signal, either, the main packet signal is sent back to the fixed node P once again.

As the transmission source of the main packet signal sent back is the mobile node W set at the top of the inquiry destination fixed node ID list, the fixed node P determines the mobile node Z set at the second of the list as the entrusting destination, and the main packet signal is entrusted to the mobile node Z. In the mobile node Z, the transmission source ID of the received main packet signal agrees with the ID set at the top of the inquiry destination fixed node ID list. Due to this, the mobile node Z also determines the fixed node T set at the second of the list as the entrusting destination. As a result, the main packet signal is entrusted to the fixed node T when the mobile node Z reached the terminal 16, and subsequently, is transferred to the desired node by way of another network.

As understood from the explanations above, a plurality of nodes used as a data signal (packet signal) transmission includes at least one mobile node and a plurality of fixed nodes. The mobile node is a node moving along the predetermined route, and the fixed node is a node fixed along the predetermined route. The data signal is sent by way of such mobile nodes and fixed nodes. In other words, the data communication between the fixed nodes (packet communication) is made by way of a mobile node.

Due to this, it is not necessary to make a communication between the fixed nodes by utilizing a strong radio wave, thus preventing a radio wave environment from deteriorating. Also, is there no need to install a cable to establish between the fixed nodes, thus making it possible to create a communication network at a low cost.

The mobile node moving on the predetermined route exists in plurality. Each of the fixed nodes fixed along the predetermined route has time information (link wait time of the profile data) showing a required time to transfer the data signal to each of the fixed nodes by way of mobile nodes, and in addition a timetable of the plurality of the above mentioned the mobile nodes. Each of the fixed nodes determines a mobile node to which the data signal is transferred from a plurality of mobile nodes based upon such time information and timetable. The mobile node to be determined is the mobile node which reaches the desired fixed node (the fixed node shown by the base node ID included in the packet signal) in the shortest time.

The mobile nodes moving on the first route Rt1 which is a travel route include a first mobile node (mobile node W) to travel in a first direction (right-handed rotation), and a second mobile node (mobile node X) to travel in the second direction (left-handed rotation). In this case, each of the fixed nodes fixed along the first route Rt1 has first time information (link wait time in regards to the mobile node W) corresponding to the first mobile node, and second time information (link wait time in regards to the mobile node W) corresponding to the second move node. Each of the fixed nodes determines the mobile node to which the data signal is transferred based upon the second time information as well as first time information and the timetable of the first mobile node and the second mobile node.

As a predetermined route, in addition to the first route Rt1, there is a second route Rt2, and each of the routes intersects at a predetermined position. To this intersecting point a predetermined fixed node (fixed node P) is fixed. At this time, each of the mobile node has first terminal information (the fixed node ID of the profile data) showing a plurality of fixed nodes assigned along the route on which itself moves, and when the desired fixed node (the fixed node shown by the node ID of the packet signal) is not in the first terminal information, the data signal is transferred to the predetermined fixed node.

The predetermined fixed node has second terminal information (fixed node ID of the profile data) showing other fixed nodes assigned along each of the first route Rt1 and second route Rt2. Due to this, the desired fixed node is specified based upon the second terminal information.

It is noted that in this embodiment a packet signal communication network system is configured by utilizing a traffic network of a regularly operating bus service. However, as a mail delivery vehicle and a vehicle of a private home delivery company also carry out a mail delivery and home delivery along a predetermined route, it may also be appropriate to configure a communication network system by utilizing a dispatch network of a mail delivery vehicle and a home delivery network of a home delivery vehicle. In utilizing the mail delivery network, the mobile node is provided in the mail delivery vehicle, and the fixed node is provided in a post office or a mailbox. In utilizing the home delivery network, the mobile node is provided in the home delivery vehicle, and the fixed node is provided in a distribution center or a home delivery locker used when the home delivery destination is absent.

In a large-scale retail store such as a department store, a store staff makes a regular rounds inside the store by using a cart in order to restock the goods. In such a large-scale retail store it is also possible to configure such a communication network system as the present invention. In this case, the mobile node is provided in the cart, and the fixed node is provided in goods display shelves in predetermined intervals.

In this embodiment a communication opponent of the mobile node provided in the regularly operating bus is basically, the fixed node provided in the stop point. Due to this, as a precondition, the fixed node is provided along the service route of the regularly operating bus. However, if a resident carrying the user node rides the regularly operating bus, and registers the ID of itself temporarily in the mobile node, then the mobile node make a communication with the user node without a help of the fixed node. By extension, it requires no fixed node if the user node is always programmed to be the telecommunication opponent of the mobile node (user node existing along the moving route).

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A communication network system to send a data signal by way of a plurality of wireless communication terminals, wherein
said plurality of wireless communication terminals includes at least one mobile communication terminal moving on a predetermined route and a plurality of fixed communication terminals fixed along said predetermined route.

2. A communication network system according to claim 1, wherein a mobile communication terminal exists in plurality, each of the fixed communication terminals include a time information storage means to store time information showing a necessary time to transfer said data signal to other fixed communication terminals by way of each of the mobile communication terminals, timetable storage means to store a timetable of each of the mobile communication terminals and specifying means to specify the mobile communication terminal to which said data signal is transferred based upon said time information and said timetable.

3. A communication network system according to claim 2, wherein the mobile communication terminal specified by said specifying means is a mobile communication terminal to reach a desired fixed communication terminal in the shortest time.

4. A communication terminal according to claim 2, wherein said predetermined route is a circulating route, the plurality of mobile communication terminals includes a first mobile communication terminal and a second communication terminal each of which circulate in a mutually reverse direction, said time information includes a first time information corresponding to said first mobile communication terminal, and second time information corresponding to said second mobile communication terminal.

5. A communication network system according to claim 1, wherein said predetermined route includes a first route and a second route contracting each other, and the specified fixed communication terminal is fixed on a contacting point of said first route and said second route, each of the mobile communication terminals includes a first terminal information storage means to store a first terminal information showing a plurality of fixed communication terminals fixed along its own moving route and a transfer means to transfer said data signal to said specified fixed communication terminal in the absence of the desired fixed communication terminal of said first terminal information.

6. A communication network system according to claim 5, wherein said specified fixed communication terminal includes a second terminal information storage means to store second terminal information showing the fixed communication terminals fixed along each of said first route and said second route.

7. A communication network system according to claim 1, wherein said mobile communication terminal is provided in a regularly operating bus, and said fixed communication terminal is provided in a stop point of the regularly operating bus.

8. A communication network system to send a data signal by way of a plurality of wireless communication terminals, wherein said plurality of wireless communication terminal includes at least one first communication terminal moving on a predetermined route, and a plurality of second communication terminals existing along said predetermined route.
